(19) United States
(12) Patent Application Publication
(10) Pub. No.: US 2007/0006022 A1
(43) Pub. Date: Jan. 4, 2007

(54) IDE control system and redundant arrays of inexpensive disk system with hot plug function therein

(76) Inventor: Kuo-Chi Chang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/415,224

(22) Filed: May 2, 2006

(30) Foreign Application Priority Data
May 3, 2005 (TW) 094114289

(51) Int. Cl. G06F 11/00

(52) U.S. Cl. 714/6

(57) ABSTRACT

An IDE control system with hot plug function and a redundant array of independent disks system (RAID) therewith. At least one reset signal pin is provided within the IDE control system and connected to IDE buses respectively, and a driver with a detecting module for detecting the unusual status from the IDE devices connected with the IDE buses is provided. When the unusual status is occurred, the reset signal pin is going to send a reset signal to reset each of IDE devices connected with the IDE buses for achieving the function of hot plug.

### FIELD OF THE INVENTION

The present invention relates to an IDE control system and redundant array of independent disks system, and more particularly to an IDE control system with hot plug function and redundant array of independent disks (RAID) system therewith, comprising at least one reset signal pin provided on the IDE control system, and a detecting module corresponding provided, so as to achieve the hot plug function within the IDE control, and improve the system stability.

### BACKGROUND OF THE INVENTION

Accordingly, current users and manufactures demand more and more transmission speed, capability, and stability for computer products, such that the manufactures are going to develop various products for the demand from consumers constantly. Due to the computer storage system, the system should be going to reset when the disk plugs or unplugs, which is occurred inconveniently for most users.

Referring to FIG. 1, is a flow chart of prior art as the disks plugging and unplugging. As the step 11, the conventional computer host is working regularly. And, once the disk is going to plug or unplug with the IDE bus, the all executing programs should be terminated at first, as the step 12. Further, the power of computer has to be turned off, as the step 13. When the power of computer is turned off, the disk can be going to plug or unplug with the IDE bus, as the step 14.

As the step 15, the power of computer is going to turn on again. When the power of computer has turned on, the computer should be going to boot up, and which can detect the new status from the IDE bus, as the step 16. And, the all disks are going to be reset, as the step 17. After resetting procedure, the computer is going to work generally, as the step 18. In accordance with the above mentioned prior art, when the disk is going to plug or unplug, the computer has to be going to reset repeatedly, and all programs have to be terminated, such that is very inconvenient.

Besides, the manufactures develop redundant array of independent disks (RAID) storage system for improving the security of computer data storage, such as the RAID 1, which comprises at least one source disk and at least one mirror disk corresponding thereof. When the data is going to be written into the source disk, the data has to be backed up within the mirror disk at meantime for preventing from data lost when one of the disks is broken. Although the RAID system can prevent form data lost when one of the disks is broken, within the same channel, when one of the source disks or the mirror disks is broken, the system may occur error, such that the system cannot work accordingly. Therefore, the computer has to be rebooted manually and going to reset, thus, the system can be used to work regularly.

Referring to FIG. 2, is a flow chart of prior art as the procedure when the RAID is broken. The system comprises a conventional RAID 1 system, having a source disk and a mirror disk therein for operation, as the step 201. Once the source disk and the mirror disk are within the same channel, as one of the disks is broken, the whole system may be crashed, as the steps 203 and 205. Thereafter, going forward to the step 207, is as deciding whether the system has to be turned off, that is, once the system is not going to turn off, the computer may not be going to work, as the step 221. And, if selecting to turn off the system, then the procedure is going to the step 211, which is to decide whether the broken disk has to be replaced of new one. If selecting to be not going to renew the broken disk, and then further proceeding to turn on the system, the system would be going to work with single disk, as the step 231. And, the system with RAID will be lost backup function, as the step 233. If selecting to renew the broken disk, then the procedure is going to the step 213. After renewing the broken disk, the system is going to be turned on; meanwhile, the computer system will reset RAID system, as the step 215. And, the computer system will recreate backup data, as the step 217. That is, the system will recover to comprise a RAID system, having the source disk and the mirror disk for further operation, as the step 219. Due to the above mentioned steps, although the internal data of the disk did not be lost, the system has to terminate all executing programs during the procedure, and manually reboot the system. And, once one of the disks within the computer system is broken, when there are not any monitors to proceed rebooting, the computer system would be fell into suspend, such that will occur problems and besetments of use.

### SUMMARY OF THE INVENTION

Accordingly, how to design an IDE control system with hot plug function and redundant array of independent disks system therewith due to the previous mentioned shortcomings of the prior art, is the key point of the present invention. Therefore,

It is a primary object of the present invention to provide an IDE control system with hot plug function, comprising a detecting module provided within a driver, and at least one reset signal pin provided within the IDE controller corresponding thereof for detecting any irregular statuses from connected IDE devices therewith, so as to reset the IDE devices to achieve the purpose of hot plugging with the IDE devices.

It is a secondary object of the present invention to provide a redundant array of independent disks (RAID) system with hot plug function, comprising a reset signal pin provided within an IDE controller, and a detecting module provided thereof for achieving the purpose of hot plugging with RAID system.

It is another object of the present invention to provide a redundant array of independent disks (RAID) system with hot plug function, comprising a reset signal pin and a detecting module corresponding thereof, as one of source disks or mirror disks of the RAID system is broken, the computer system would not be rebooted necessarily, and could be reset automatically the disk provided on the channel, such that surely benefits for operating continuously.

To achieve the previous mentioned objects, the present invention provides an IDE control system with hot plug function, comprising an IDE controller, connected with at least one IDE bus, and coupled to at least one IDE device through the IDE bus; and a driver for driving the IDE controller and the IDE device connected therewith; wherein the driver comprises a detecting module, the IDE controller comprises at least one reset signal pin, and the reset signal pin sends a reset signal to reset the IDE device connected therewith when the detecting module detects that said IDE device is in an irregular status.

The present invention further provides A redundant array of independent disks (RAID) system with hot plug function, comprising a RAID controller having at least one IDE controller, each IDE controller connected with at least one IDE bus, the RAID controller coupled to a plurality of array disks through the IDE controller and the IDE bus; and a driver for driving the RAID controller and the array disks coupled therewith; wherein the driver comprises a detecting module, each IDE controller comprises at least one reset signal pin, and the reset signal pin sends a reset signal to reset said array disks coupled therewith when said detecting module detects that said RAID is in an irregular status.

### BRIEF DESCRIPTION OF THE DRAWINGS

It will be understood that the figures are not to scale since the individual layers are too thin and the thickness differences of various layers too great to permit depiction to scale.

FIG. 1 is a flow chart of prior art as the disks plugging and unplugging;

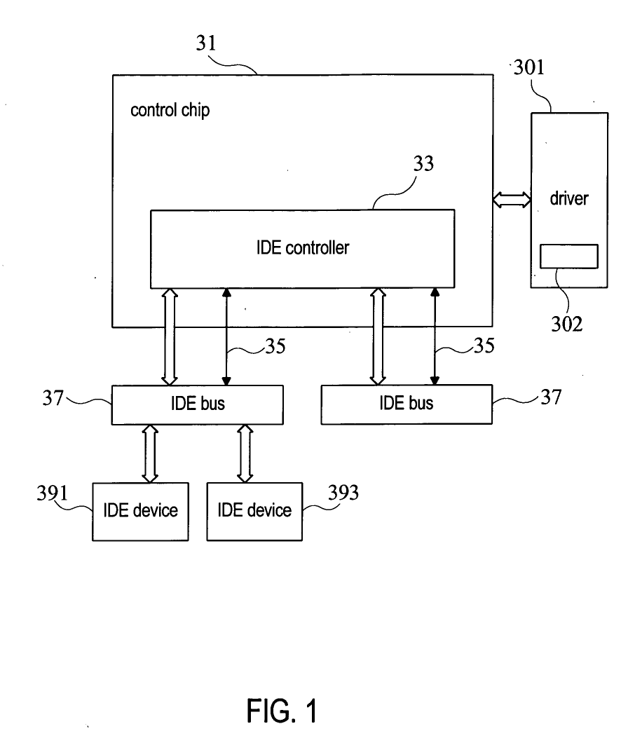

FIG. 2 is a flow chart of prior art as the procedure when the RAID is broken;

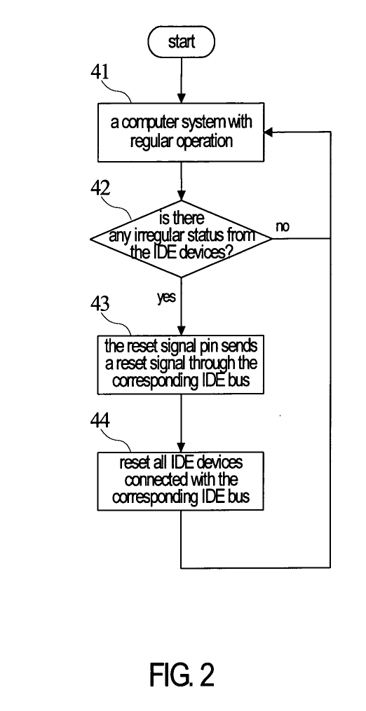

FIG. 3 is a block diagram of a preferred embodiment of the present invention;

FIG. 4 is a flow chart of an application method of the preferred embodiment of the present invention;

FIG. 5 is a block diagram of another preferred embodiment of the present invention; and

FIG. 6 is a flow chart of an application method of another preferred embodiment of the present invention.

### DETAILED DESCRIPTION OF THE INVENTION

The structural features and the effects to be achieved may further be understood and appreciated by reference to the presently preferred embodiments together with the detailed description.

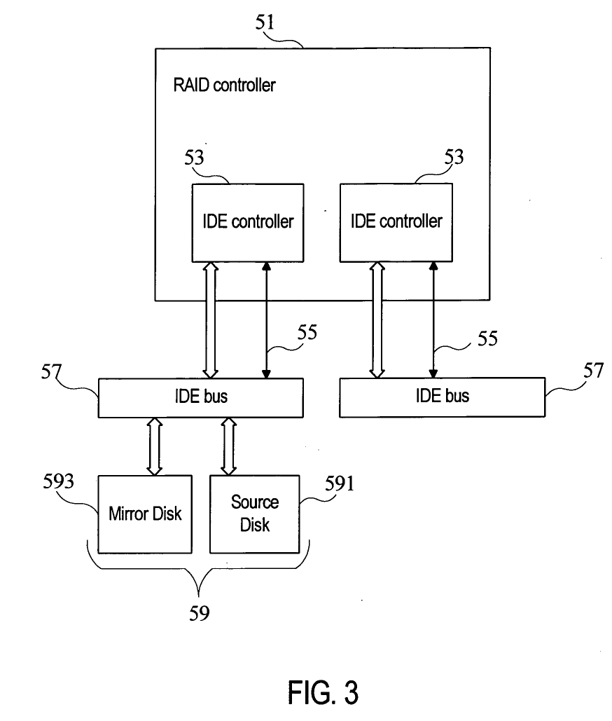

Referring to FIG. 3, a block diagram of a preferred embodiment of the present invention is showed. A control chip 31 comprises an IDE controller 33 connected with at least one IDE bus 37, which connects with at least one IDE device through IDE slot provided on the IDE bus 37, such as IDE device 391 and IDE device 393. The system comprises a driver 301 in a storage device, such as DRAM, for driving the IDE controller 33 and the IDE devices 391 and 393 connected therewith. The driver 301 further comprises a detecting module 302 for detecting whether any irregular status is occurred from the IDE devices 391 and 393 connected with the IDE bus 37.

And, the IDE controller 33 further respectively comprises a reset signal pin 35 corresponding with each IDE bus 37. When the detecting module detects an irregular status from the IDE devices 391 and 393, the driver sends a reset signal through the reset signal pin 35 to reset all IDE devices connected with the IDE bus 37. The irregular status comprises a plugging status, an unplugging status, and a broken status for the IDE device.

The above mentioned detecting module can be designed with a system clock function, which can be used to control the time period of detecting the IDE devices 391 and 393 connected with the IDE bus 37 by the detecting module, such as according to the setting of the system clock function, the detecting time period of the detecting module can be set as 1 second, then the detecting module will proceed to detect the IDE devices 391 and 393 by every 1 second. Of course, the system clock function can be adjusted by the demand of users. If the demand is required to advance the stability for the system, then the detecting frequency can be higher correspondingly.

The IDE devices 391 and 393 connected with the IDE bus 37 can be selectively as one of a disk and a CD-Rom drive. The IDE controller 33 can be integrated into the control chip 31 or provided on a motherboard (not shown), or provided on a peripheral component interconnection (PCI) interface card plugged in a PCI slot within the motherboard. The above mentioned control chip 31 of the IDE controller 33 can be selectively as one of a South Bridge, North Bridge, or South and North Bridge integration control chip.

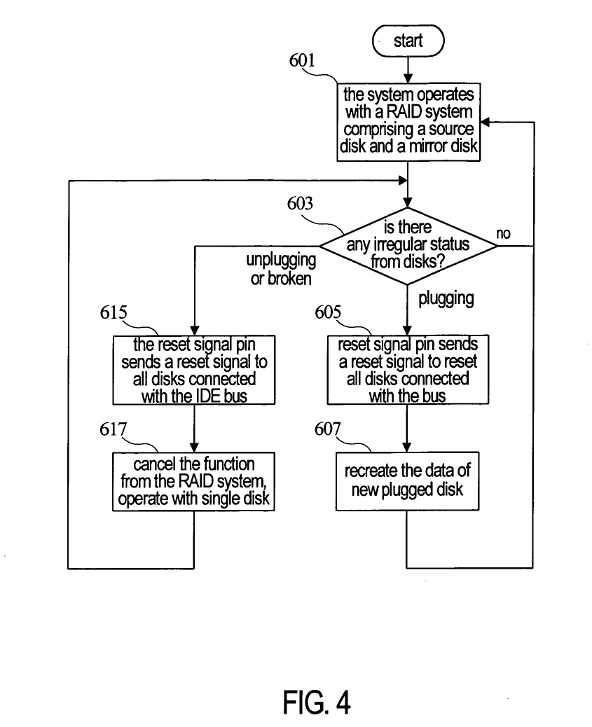

Referring to FIG. 4, is a flow chart of an application method of the preferred embodiment of the present invention. At first, the system is as a computer system with regular operation, as the step 41. The detecting module within the driver (not shown) is going to detect whether any irregular status is occurred from the IDE devices (such as the devices 391 and 393) connected with each IDE bus 37, as the step 42. If each IDE devices have not any irregular status, then the computer would be operation continuously; and if one of IDE devices occurs an irregular status, then the procedure would be going to the step 43. The reset signal pin 35 of the IDE controller 33 sends a reset signal through the corresponding IDE bus 37, as the step 43. After all IDE devices connected with the corresponding IDE bus 37 receiving the reset signal, the system is going to proceed the reset procedure, as the step 44. As finishing to reset all IDE devices, the computer system can be recovered to as the regular operation status, as the step 41.

During the operation period for the general computer system, as the irregular status occurred from the IDE device, no matter what is the plugging status, the unplugging status, or the broken status, the system will occur error and be further going to crash. However, the present invention can reset the IDE device connected with the corresponding IDE bus, when the irregular status is occurred. Therefore, the system will not necessarily be rebooted, and be going to operate continuously, such that the purpose of hot plugging function for the IDE device is achieved.

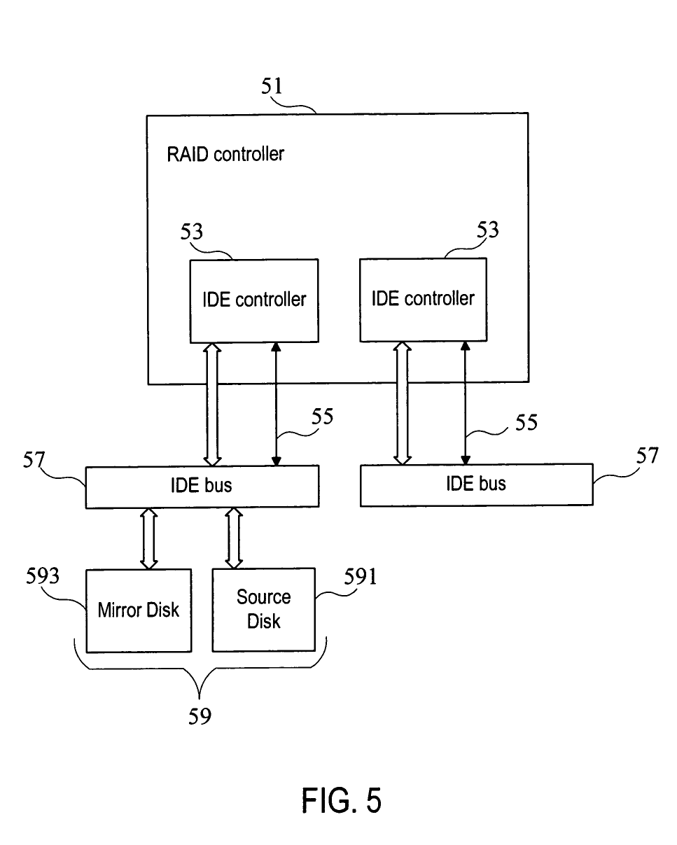

Referring to FIG. 5, is a block diagram of another preferred embodiment of the present invention. The present invention can be applied into a redundant array of independent disks (RAID) system, comprising at least one IDE controller 53 provided on a RAID controller 51, at least one IDE bus 57 connected with each IDE controller 53, wherein the RAID controller 51 connects with a plurality of array disks 59 through the IDE controller 53 and the IDE bus 57. The RAID comprises a driver (not shown) for driving the RAID controller 51 and array disks 59 connected therewith. The driver further comprises a detecting module for detecting whether any irregular status is occurred from the array disks 59 connected with each IDE bus 57.

And, corresponding to each IDE bus 57, each IDE controller 53 further respectively comprises a reset signal pin 55. When the detecting module detects an irregular status from each array disks 59, the driver will send a reset signal from the reset signal pin 55 to reset all array disks 59 connected with the IDE bus 57. The above mentioned irregular status comprises the plugging status, the unplugging status, or the broken status for the array disks 59.

The detecting module further comprises a system clock function. The system clock function can control the time period of detecting the array disks 59 connected with each IDE bus 57 by detecting module. For example, according to the setting of the system clock function, the detecting time period of the detecting module can be set as 1 second; therefore, the detecting module is going to detect each array disks 59 every 1 second. Of course, the system clock function can be adjusted by the demand of users. If the demand is required to advance the stability for the system, then the detecting frequency can be higher correspondingly.

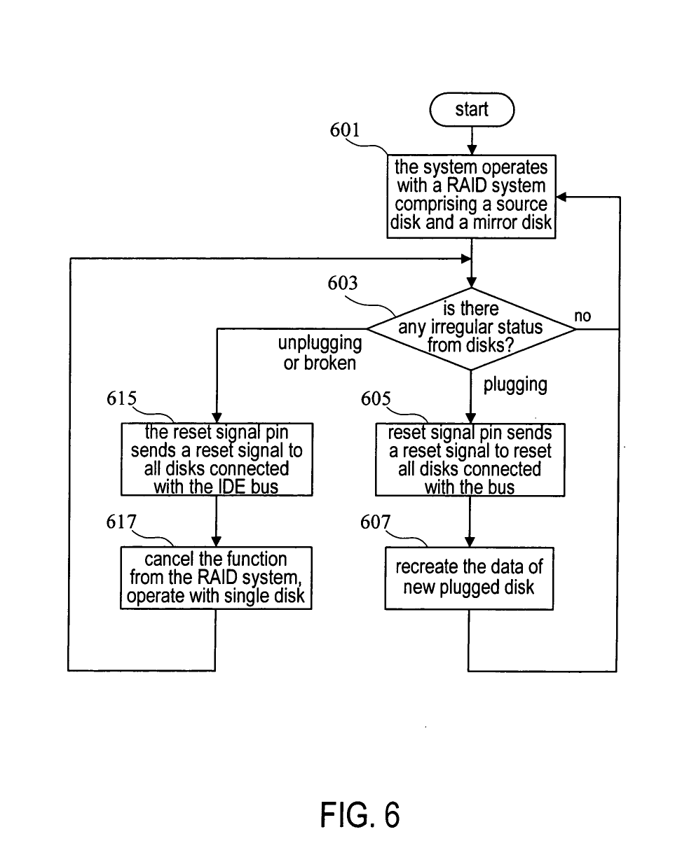

Finally, referring to FIG. 6, is a flow chart of an application method of another preferred embodiment of the present invention. The RAID system is as a RAID 1 system, comprising at least one source disk 591 and at least one mirror disk 593 corresponding thereof, which can further provide stability for the system.

At first, the system operates with a RAID system, comprising a source disk 591 and a mirror disk 593, as the step 601. During the system operation period, the detecting module within the driver is going to detect whether any irregular status is occurred from each disk connected with each IDE bus 57 continuously, as the step 603. If there is nothing irregular status occurred, then the system would operate regularly and back to the step 601. And, if there is an irregular status occurred by unplugging or broken for the source disk 591 or the mirror disk 593, then the reset signal pin 55 would send a reset signal to all disks connected with the IDE bus 57 to proceed the reset procedure, as the step 615. Thereafter, the system will cancel the function from the RAID system, and operate with single disk, as the step 617.

When the system operates with single disk, the detecting module still detects whether any irregular status is occurred from the disk connected with the IDE bus 57, as the step 603. When the detecting module detects an irregular status for plugging a new disk, then the corresponding reset signal pin will send a reset signal to reset all disk connected with the bus, as the step 605. After finishing the reset procedure, the plugged disk data has to be recreated, as the step 607. After recreating the data, the computer system can be recovered to operate regularly with the RAID system, comprising the source disk 591 and the mirror disk 593.

Of course, although the above mentioned embodiments describes a source disk 591 and a mirror disk 593 within the RAID system, in different embodiment, the source disk 591 and the mirror disk 593 can be designed as plurality.

In summary, it is appreciated that the present invention relates to an IDE control system and redundant array of independent disks system, and more particularly to an IDE control system with hot plug function and redundant array of independent disks system therewith, comprising at least one reset signal pin provided on the IDE control system, and a detecting module corresponding provided, so as to achieve the hot plug function within the IDE control, and improve the system stability.

The foregoing description is merely one embodiment of present invention and not considered as restrictive. All equivalent variations and modifications in process, method, feature, and spirit in accordance with the appended claims may be made without in any way from the scope of the invention.

1. An IDE control system with hot plug function, comprising:
an IDE controller, connected with at least one IDE bus, and coupled to at least one IDE device through said IDE bus; and
a driver for driving said IDE controller and said IDE device connected therewith;
wherein said driver comprises a detecting module, said IDE controller comprises at least one reset signal pin, and said reset signal pin sends a reset signal to reset said IDE device connected therewith when said detecting module detects that said IDE device is in an irregular status.

2. The IDE control system of claim 1, wherein said reset signal pins are corresponding to said IDE buses respectively.

3. The IDE control system of claim 2, wherein said reset signal pin connected with said IDE bus sends a reset signal to reset said IDE devices connected therewith when said IDE devices is detected in said irregular status.

4. The IDE control system of claim 1, said detecting module further comprising a counting function.

5. The IDE control system of claim 1, wherein said irregular status is one of a plugging status, an unplugging status, and a broken status.

6. The IDE control system of claim 1, wherein said IDE controller is integrated into one of a motherboard, a control chip, and a PCI interface card.

7. The IDE control system of claim 1, wherein said IDE device is one of a disk and a CD-Rom drive.

8. A redundant array of independent disks (RAID) system with hot plug function, comprising:
a RAID controller having at least one IDE controller, each IDE controller connected with at least one IDE bus, said RAID controller coupled to a plurality of array disks through said IDE controller and said IDE bus; and
a driver for driving said RAID controller and said array disks coupled therewith;
wherein said driver comprises a detecting module, each IDE controller comprises at least one reset signal pin, and said reset signal pin sends a reset signal to reset said array disks coupled therewith when said detecting module detects that said RAID is in an irregular status.

9. The RAID system of claim 8,. wherein said reset signal pins are corresponding to said IDE buses.

10. The RAID system of claim 9, wherein said reset signal pin connected with said IDE bus sends a reset signal to reset said RAID connected therewith when said RAID is detected in the irregular status.

11. The RAID system of claim 8, said detecting module further comprising a counting function.

12. The RAID system of claim 8, wherein said irregular status is one of a plugging status, an unplugging status, and a broken status.

13. The RAID system of claim 8, wherein said IDE controller is integrated into one of a motherboard, a control chip, and a PCI interface card.

14. The RAID system of claim 8, wherein said IDE device is a disk.

15. The RAID system of claim 8, wherein said RAID system comprises at least one source disk and at least one mirror disk corresponding thereof.

16. The RAID system of claim 8, wherein said RAID system is a RAID 1 system.
